(19) United States
(12) Patent Application Publication
(10) Pub. No.: US 2004/0073463 A1
(43) Pub. Date: Apr. 15, 2004

(54) Apparatus, methods and computer software products for clinical study analysis and presentation

(76) Inventors: Russell W. Helms, Chapel Hill, NC (US); Ronald W. Helms, Chapel Hill, NC (US)

Correspondence Address: MYERS BIGEL SIBLEY & SAJOVEC, PO BOX 37428, RALEIGH, NC, 27627, US

(21) Appl. No.: 10/640,561

(22) Filed: Aug. 13, 2003

Related U.S. Application Data
(60) Provisional application No. 60/403,072, filed on Aug. 13, 2002.

(51) Int. Cl. G06F 17/60

(52) U.S. Cl. 705/3

(57) ABSTRACT

An integrated clinical analysis database may include clinical data from observations of study subjects of a population of study subjects of a clinical study and metadata that defines a structuring of the clinical data that supports generation of a statistical analysis of the population of study subjects specified by study documentation of the clinical study. The metadata provides statistical variable definitions for the statistical analysis such that plural instances of the statistical analysis can be generated without determining new values for the statistical variables. Respective statistical analysis instructions may be accepted and, in response, the clinical study analysis database may be accessed and respective statistical computations may be performed using the statistical variables to generate respective instances of the statistical analysis. A user interface for presentation of the statistical analysis may be provided using, e.g., a web server. An integrated clinical study analysis database may include data and derivative data from study subjects, structured such that a statistic and/or a table value specified in documentation for the clinical study can be computed using published equations applied directly to existing values of variables in the database, and which includes at least two of: a dataset structured one record per subject; a dataset structure one record per visit per subject; a data structured one record per measurement occasion per visit per subject; and a dataset structured one record per event per subject.

### RELATED APPLICATION

The present application claims the benefit of and priority from U.S. Provisional Application Serial No. 60/403,072, entitled “Clinical Trials Analysis Database and User Interfaces,” filed Aug. 13, 2002 (Attorney Docket No. 9352-2PR), the content of which is incorporated by reference herein in its entirety.

### BACKGROUND OF THE INVENTION

The present invention relates to managing clinical study information, and more particularly, to methods, systems and software products for managing and presenting clinical study information.

A typical clinical trial involves the administration of a compound to a population of study subjects and the collection of clinical data that may exhibit statistical significance in judging the safety (including adverse effects) and efficacy of the administered compound. For example, clinical trials of new drugs can provide information from which conclusions regarding potential effectiveness, desirable dosage and the likelihood of possible adverse side effects can be drawn. Government agencies typically require such information for approval of the sale of a new drug.

The development program for a new drug is typically a long and complex processes involving multiple phases, each of which may include multiple studies. Studies with human subjects are called clinical trials. A typical Phase I trial may evaluate how a new drug should be given (by mouth, injected into the blood, or injected into the muscle), how often, and what dose is safe. A Phase I trial typically enrolls only a small number of patients, sometimes as few as a dozen. A Phase II trial typically continues to test the safety of the drug, and begins to evaluate how well the new drug works. Phase III trials typically include studies that test a new drug, a new combination of drugs, or a new surgical procedure in comparison to the current standard for treatment. Phase III trials often enroll large numbers of people and may be conducted at many doctors' offices, clinics, and medical centers nationwide or in multiple countries.

Clinical trials typically involve the collection of a large amount of data representing observations and measurements of study subjects, for example, observed bodily states, such as blood pressure and heart rate, and/or bodily functions, such urinary output and hours slept, and/or events, such as acute disease events (e.g., heart attack, stroke, etc.) and adverse reactions. Data may be collected in a number of different ways, including by the use of paper forms, instruments (e.g., for performing analyses of blood samples), or input provided directly into computers.

This raw data typically must be processed using statistical methods to develop meaningful measures of the efficacy and safety of a proposed drug or treatment. Such analysis typically involves the identification of correlations among study variables (e.g., age, sex, test environment, measurements of efficacy, adverse events, etc). The statistical analysis is then typically reviewed by parties managing the studies and by management of the company or companies sponsoring the research. Ultimately, conclusions regarding the statistical analysis are presented to an appropriate regulatory body, e.g., the Food and Drug Administration, as part of an approval process.

Medical research on human subjects is generally very complex and resulting clinical trials data is typically very complicated. Intricate dataset manipulations are typically required to create “analysis datasets” that have structures suitable for statistical analyses. This may make it difficult for project management or a regulatory agency to evaluate a study because of questions about the clinical data and/or the methodology used in generating analytical conclusions from the data. In addition, it may be difficult to generate new statistical analyses for different subpopulations and/or other constraints without extensive and time-consuming regeneration of analysis datasets.

### SUMMARY OF THE INVENTION

Some embodiments of the present invention arise from a realization that evaluation of clinical study information may be improved by providing an integrated clinical study analysis database that includes both clinical data, organized into analysis datasets that are structured to facilitate statistical analyses, and “metadata” that defines the structure of the database. Such an integrated clinical study analysis database can provide a tool that enables a reviewer, such as a project manager, company manager and/or a regulatory agency, to access not only study conclusions, but also the underlying clinical data and the analytical framework used to generate such conclusions from the underlying clinical data, such as statistical assumptions and models used to generate the conclusions, variables used in generating the conclusions, and anomalies (e.g., implausible data and/or computational errors) associated with the clinical data. Such an integrated clinical study analysis database may also be used to generate new statistical analyses, e.g., for subpopulations, without requiring reprocessing of raw clinical data. According to further aspects of the present invention, such an integrated clinical study analysis database can be accessed using a computer-implemented apparatus that accesses the database and supports presentation of information therefrom. For example, a web server may be configured to provide access to an integrated clinical study analysis database from a client application, such as a web browser, running on a computer networked to the server.

In particular, according to some embodiments of the present invention, an integrated clinical study analysis database may be provided. The integrated clinical study analysis database comprises clinical data from observations of study subjects of a population of study subjects of a clinical study and metadata that defines a structuring of the clinical data that supports generation of a statistical analysis of the population of study subjects specified by documentation of the clinical study. The metadata provides statistical variable definitions for the statistical analysis such that plural instances of the statistical analysis can be generated without determining new values for the statistical variables. The clinical data may be organized into analysis datasets that are structured to facilitate statistical analyses, and the metadata may define the structure of the clinical data datasets. The metadata may provide variable definitions (including original data variables and/or derived variables) for the statistical analysis, and the analysis datasets may be structured such that plural instances of the statistical analysis can be generated without determining new values for the variables. Respective statistical analysis instructions may be accepted and, in response, the clinical study analysis database may be accessed and respective statistical computations may be performed using the variables to generate respective instances of the statistical analysis. A user interface for presentation of the statistical analysis, e.g., using a web server, may also be provided.

According to further aspects of the present invention, an integrated clinical study analysis database comprises data and derivative data from study subjects, structured such that a statistic and/or a table value specified in documentation for the clinical study can be computed using published equations applied directly to existing values of variables in the database. The integrated clinical study analysis database includes at least two of the following: a dataset structured one record per subject; a dataset structure one record per visit per subject; a data structured one record per measurement occasion per visit per subject; and a dataset structured one record per event per subject.

The present invention may be embodied in many forms, including software products, computer apparatus and methods.

### BRIEF DESCRIPTION OF THE DRAWINGS

FIG. 1 is a schematic diagram illustrating systems and operations for providing and accessing an integrated clinical study analysis database according to some embodiments of the present invention.

FIG. 2 is a schematic diagram illustrating an integrated clinical study analysis database according to some embodiments of the present invention.

FIG. 3 is a schematic diagram illustrating operations for creating a compound analysis database from a plurality of study analysis databases according to further embodiments of the present invention.

FIGS. 4-25 are computer screen shots illustrating operations for accessing and presenting information from an integrated clinical study analysis database according to some embodiments of the present invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements. It will be understood that when an element is referred to as being “connected” or “coupled” to another element, it can be directly connected or coupled to the other element or intervening elements may be present.

The present invention may be embodied as apparatus (systems), methods, and/or articles of manufacture, including software products, such as databases and/or computer programs embodied in computer-readable media. Accordingly, the present invention may be embodied in hardware and/or in software (including firmware, resident software, micro-code, data structures, etc.). Furthermore, the present invention may take the form of a computer program product on a computer-usable or computer-readable storage medium having computer-usable or computer-readable code embodied in the medium for use by or in connection with an instruction execution system. In the context of this document, a computer-usable or computer-readable medium may be any medium that can contain, store, communicate, propagate, or transport the code for use by or in connection with the instruction execution system, apparatus, or device.

The computer-usable or computer-readable medium may be, for example, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber and a portable compact disc read-only memory (CD-ROM). Note that the computer-usable or computer-readable medium could even be paper or another suitable medium upon which code is printed, as the code can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, apparatus and software products in accordance with exemplary embodiments of the invention. It will be understood that each block of the flowchart and/or block diagram illustrations, and combinations of blocks in the flowchart and/or block diagram illustrations, may be implemented by computer code and/or hardware operations. Such computer code may be provided to a processor of a general purpose computer, a special purpose computer, or other programmable data processing apparatus to produce a machine, such that the code, which is executed and or processed via the processor of the computer or other programmable data processing apparatus, create means for implementing the functions specified in the flowchart and/or block diagram block or blocks.

The computer code may also be stored in a computer-usable or computer-readable memory that may direct a computer or other programmable data processing apparatus to function in a particular manner, such that the code stored in the computer-usable or computer-readable memory produce an article of manufacture including code that implements the function specified in the flowchart and/or block diagram block or blocks. The computer code may also be loaded onto and/or read by a computer or other programmable data processing apparatus to cause a series of operational steps to be performed on the computer or other programmable apparatus to produce a computer implemented process such that the code, in conjunction with the computer or other programmable apparatus, implements the functions specified in the flowchart and/or block diagram block or blocks.

According to some embodiments of the present invention, an integrated clinical study analysis database may be provided in the form of a software product embodied in a computer-accessible medium. The software product may include an integrated clinical study database comprising clinical data, which includes information about study subjects and integrated metadata, which includes information about the structure and contents of the database. Together, the clinical data and the metadata can support pre-specified statistical computations and analyses associated with a clinical study, i.e., defined in an analysis protocol for the study, in a “one-proc-away” mode, i.e., without requiring dataset re-organization or dataset manipulation. For example, such an integrated clinical study analysis database can support multiple statistical computations and analyses, e.g., at different times, for different subpopulations, and the like, without requiring reprocessing of raw clinical data. In some embodiments of the present invention, the metadata includes “scientific metadata,” i.e., information that describes scientific models and/or techniques used in performing the study or that describes scientific models and/or techniques used in creating the integrated clinical study analysis database. For example, the scientific metadata may include a “Variable Glossary” dataset or collection of datasets containing one record and/or one document file for each variable in the database. Each Variable Glossary may contain, for example, an essay-level description of each variable in the database. The scientific metadata may also include a “Quirks Glossary” dataset or collection of datasets containing a record and/or document file for each “Quirk,” i.e., a scientific issue arising from or relating to data in the database. A Quirk Glossary may describe a Quirk, together with documentation of actions taken to cope with or work around the issue. The scientific metadata may also include a “Bug Glossary” dataset or collection of datasets containing one record and/or one document file for each “Bug,” i.e., a data error in the database that was detected, but not corrected, by the database creators. A Bug Glossary may describe a Bug, together with additional relevant documentation. The scientific metadata may further include a “BugType” dataset or collection of datasets having entries that describe respective types of data error in the database that was detected, but not corrected, by the database creators. Examples of BugTypes include rounding errors, differing interpretations of variables due to vague documentation, and incorrect algorithms used for computing derived variables. The scientific metadata may further include a “Scientific Decisions” dataset or collection of datasets having entries that describe respective decisions regarding methods of coping with scientific data issues. For example, a study's protocol may specify that one set of baseline lab determinations be made but, in certain circumstances, multiple baseline lab determinations were made. A Scientific Decisions entry might describe how the creators of the database chose to cope with multiple baseline values in the creation of change-from-baseline variables. In another example, the metadata may include a “Scientific Documents” dataset or collection of datasets having entries that contain scientific or medical information relevant to the study represented by the integrated clinical study analysis database. Examples of sources of Scientific Documents include: a paper, article, abstract, or similar document from a medical or scientific journal, periodical, or similar publication; information, notes, or visual aids from a presentation at a scientific or research conference; information from an internet publication or website; a link to such a document on an internet website.

According to further embodiments of the present invention, the database structure may include some of the following types of datasets: a one-record-per-patient dataset (e.g., a “Subject” dataset); a one-record-per-visit-per-patient dataset (e.g., a “Visit” dataset); a one-record-per-measurement occasion-per-visit-per-patient dataset, (e.g., a “Panel” dataset (because such data are often captured in multiple “panels” on one page of a data form); a one-record-per-adverse event-per-patient dataset; a one-record-per-concomitant medication-per-patient dataset; an event-related dataset containing information that is captured as a result of a type of unscheduled event (other than adverse events or concomitant medications); an “Image” dataset containing a file containing one or more computer-accessible images, which are a computer representation of images of data forms containing patient data, images or graphics generated by instruments (e.g., radiographs, electrocardiograms, magnetic resonance images, images of electrophoresis gels), or other images relevant to the study; a “Submission” dataset that is intended for submission to a regulatory agency, such as the Food and Drug Administration and that is intended comply with the regulatory agency's instructions or regulations; and/or a “Genetic” (or “Familial”) dataset that contains information on familial relationships among participants in the study and their relatives, genotypes, phenotypes, results of DNA, RNA, or other genetic analyses, and/or microarray data.

According to further aspects of the invention, the metadata may include structure datasets, including, for example: a one-record-per-study “Study” metadata dataset that contains summary descriptions of the study; a one-record-per-dataset “Dataset” dataset that contains specifications of every dataset in the database; a one-record-per-variable “Variable” dataset that contains detailed specifications of all variables in all datasets in the database; a one-record-per-study-document “Study Documents” dataset that contains specifications of all study document datasets in the database; and/or a dataset or collection of “Submission Metadata” datasets that contain detailed specifications of all datasets for a submission to regulatory authorities, e.g., the Food and Drug Administration.

Study Documents may include, for example: a study protocol; a blank data form used in gathering clinical data for the study; a blank data forms annotated with names of variables used in the database for the fields on the data forms; a data management plan; a statistical analysis plan; a randomization plan or schedule; a schedule of treatment assignments; a model informed consent form; a blank informed consent form, as proposed to or approved by Institutional Review Boards at the study's clinical centers; a study administration document, e.g., a document used for planning the study, scheduling the study, organizing the study, staffing the study, recruiting or managing clinical sites, managing the study, monitoring the study, etc.; a clinical monitor report; a report of an interim analysis; a report to a Data and Safety Monitoring Board; a report of some or all of the results of the study, as for example, a final study report or a comprehensive study report; a data listing of some or all of the data from the study; a table computed from the database; a figure or graph computed from the database; a correspondence with a regulatory authority, e.g., the Food and Drug Administration; a report to a regulatory authority; and/or a drafts of any of the above types of documents.

According to further embodiments, the integrated clinical study analysis database may include an analysis dataset including a comprehensive set of virtually all variables that are captured for the type of measurement occasion represented by a record in the dataset. For example, a one-record-per-patient dataset contains a comprehensive set of virtually all variables that represent data captured once per patient or that represent once-per-patient information. These variables may contain identification information, population membership information, measurements, observations, information derived from other variables, selection information, and summary statistics. For example, a “Subject” dataset may include an entirely comprehensive set of virtually all variables that are captured or computed on a once-per-patient basis; a “Visit” dataset may include an entirely comprehensive set of virtually all variables that are captured or computed on a once-per-patient-per-visit basis; a “Panel” dataset may include an entirely comprehensive set of virtually all variables that are captured or computed on a once-per-patient-per-visit-per-panel basis; an “Adverse Event” dataset may include an entirely comprehensive set of virtually all variables that are captured or computed on a once-per-patient-per-adverse-event basis; and/or a “Concomitant Medications” dataset may include an entirely comprehensive set of virtually all variables that are captured or computed on a once-per-patient-per-concomitant medication-event basis.

In further embodiments of the present invention, an analysis dataset may include dummy records. For example, an analysis dataset could contain records for all scheduled measurement occasions, regardless of whether the measurement actually occurred. A dummy record may be created for each scheduled measurement occasion that did not actually occur. In a dummy record, the values of identification, selection, and certain other variables may be copied from one or more higher-level datasets. As an example, a dataset with one-record-per-patient is a higher-level dataset than a dataset with one-record-per-patient-visit, which would be the more detailed dataset. Within a dummy record, variables representing measurements, observations, statistics, and derived variables may be set to contain missing-value codes. The analysis dataset may contain an indicator variable that specifies whether each record is a dummy record or not. Similar dummy records can be provided in “Subject,” “Visit,” “Panel” and other datasets.

In further embodiments, an analysis dataset may include variables that can be used in secondary analyses, ad hoc analyses, and unanticipated analyses that are scientifically legitimate in the context of the study. An analysis dataset may include variables that allow the user to explore alternative solutions to scientific problems discovered in the data during the process of creating the analysis database. For example, one type of scientific problem is the presence, in a variable, of outliers or not-credible data values. An analysis dataset may include a variable that contains all observed or measured data values, without regard to whether the data values are reasonable; such a variable may be used for an “all cases analysis.” The database may also include one or more additional variables from which one or more subsets of not-credible data values have been discarded (set to missing value codes). Such variables may be useful for exploring the sensitivity of statistical analysis results to outliers or not-credible data.

One or more analysis datasets may include variables that store one type of information in two or more internal formats or representations. For example, a variable that stores a “yes” or “no” answer to a question may be stored: (1) as a character variable with values “YES” and “NO”; and (2) as a numeric variable with values 1 (corresponding to “YES”) and 0 (corresponding to “NO”). One or more analysis datasets may include specialized redundant variables that facilitate statistical analyses. For example, when a variable may be used as a regressor, two versions of the variable may be provided: (1) a variable containing the values as captured; (2) a variable containing a centered version of the variable (original values minus the approximate mean). In some circumstances, statisticians prefer regression on centered regressor variables; in other circumstances statisticians prefer regression on non-centered regressor variables.

In further embodiments of the invention, one or more analysis datasets include variables that have been “subsetted” to represent subsets of records (patients, patient-visits, etc.) that are important or interesting in interpreting the results of a study. To “subset” a variable for a specified subset of records: (1) in records in the specified subset, values of the variable may be retained; (2) in records in the complementary subset, values of the variable may be set to missing value codes; and optionally, (3) an indicator variable may be created for the specified subset. Examples of interesting subsets include: records in the intent-to-treat set, records in the per-protocol set. One or more analysis datasets may include statistics or derived variables that have been computed from subsetted variables.

According to further aspects of the present invention, information from a detailed dataset may be stored in a higher level dataset. As an example, a dataset with one-record-per-patient may be considered a higher-level dataset that a dataset with one-record-per-visit-per-patient, which would be the more detailed dataset. Higher level datasets may include “Detail Variables” that contain “rolled out” data from a more detailed dataset. Each Detail Variable may contain data from one measurement, observation, statistic, or derived variable from one record of the more detailed dataset. There may be multiple Detail Variables, each representing one type of record from the more detailed dataset. One or more higher level datasets may includes “Adverse Event Variables” and “Treatment Emergent Adverse Event Variables” that may contain information about adverse events and treatment emergent adverse events that are important in the context of the study. One or more higher level datasets may include “Baseline Variables,” which may be comprehensive in that they contain virtually all important baseline data. Each Baseline Variable may contain initial or pre-treatment data from one measurement, observation, statistic, or derived variable from the initial or pretreatment record of the more detailed dataset. One or more higher level datasets may include “Endpoint Variables” and/or “Outcome Variables” that contain endpoint and outcome data, respectively. The Endpoint Variables and Outcome Variables may be comprehensive in that they contain virtually all important endpoint data and outcome data. Each Endpoint Variable may contain data from one endpoint measurement, observation, statistic, or derived Endpoint Variable from the endpoint record(s) of the more detailed dataset. Each Outcome Variable may contain data from one outcome measurement, observation, statistic, or derived Outcome Variable from the outcome record(s) of the more detailed dataset. One or more higher level analysis datasets may include summary statistics, whose values are computed from the records of more detailed datasets, such as a one-record-per-patient-visit-panel dates, an Adverse Events dataset, a Concomitant Medications dataset, and/or other datasets.

According to additional aspects, information from higher level datasets may be stored in detail datasets. For example, a dataset with one-record-per-patient is a higher-level dataset than a dataset with one-record-per-patient-visit, which would be the more detailed dataset.

In further embodiments, a Variables metadata dataset may contain two or more of the following types of information (when relevant) about a variable: short (SAS Version 5 compliant) variable name and long (SAS Version 8+ compliant) variable name; short (SAS Version 5 compliant) variable label and long (SAS Version 8+ compliant) variable label; a character string variable that contains the specification of the algorithm for computing the value of a statistic or derived variable, including text, equations, etc., as needed; a character string variable that includes specifications for modifying the computational algorithm for this variable when the data contains missing values; a link to the location of the variable as a data field in an image of an annotated data form; a link to a Variable Glossary, which provide documentation of the variable.

In further embodiments of the present invention, the database contains the study's operational datasets. In contrast to analysis datasets, operational datasets are the datasets produced by the study's clinical data management system in the process of capturing and cleansing the study's data.

According to further aspects of the present invention, a collection of tools for accessing or navigating a Study Analysis and Repository Database (integrated clinical study analysis database) or Compound Analysis and Repository Database (CARD), or for viewing information stored in a integrated clinical study analysis database or CARD, may be provided. For example, a software product may comprise computer program code that is executable to provide a user interface for presentation of a integrated clinical study analysis database or CARD. The software product may, for example, provide a set of tools for any of the following: finding and/or viewing predefined analysis displays; finding and/or viewing structural metadata for any predefined analysis display; finding and/or viewing metadata relating to the variables used to create any pre-defined analysis display; finding and/or viewing scientific metadata for any pre-defined analysis display; finding and/or viewing program code used to generate a validation display; finding and/or viewing analysis data used to generate any pre-defined analysis display; sorting, graphing, and calculating univariate and/or bivariate statistics about the analysis data; revising a subset of the analysis data; recreating an analysis display with the analysis data as manipulated by the user; sorting, graphing, calculating univariate and/or bivariate statistics about the analysis data as manipulated by the user.

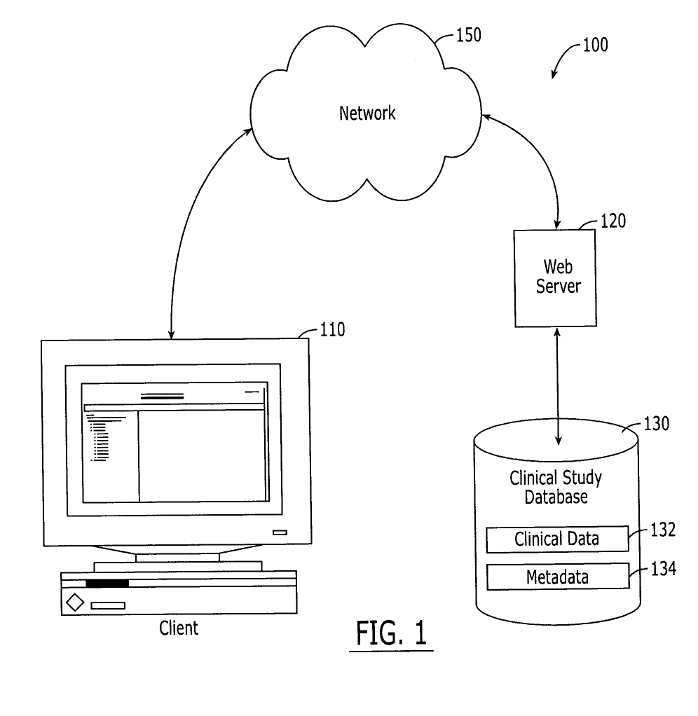

FIG. 1 illustrates an exemplary system 100 for providing clinical analysis information according to some embodiments of the present invention. A web server 120 provides access to an integrated clinical study analysis database 130 from a client 110 via a network 150. For example, the client 110 may comprise a computer running a web browser that accesses a web site maintained by the web server 120 and that provides access to the integrated clinical study analysis database 130. The clinical study analysis database 130 includes clinical data 132 from study observations, which may include both direct observation data, e.g., clinical measurements such as blood pressure, and data derived from such observation data. The clinical study analysis database 130 further includes metadata 134 that defines a structuring of the clinical data 132 that supports generation of a statistical analysis of a population of study subjects specified by a protocol or statistical analysis plan of a clinical study.

According to some aspects of the present invention, the metadata 134 may provide statistical variable definitions for the statistical analysis such that plural instances of the statistical analysis can be generated without determining new values for the statistical variables. For example, the metadata 134 may structure the clinical data 132 in the form of statistical variable data records for a study population, which are in a form suitable for direct use in various published statistical equations. In this manner, multiple statistical analyses, e.g., statistical analyses for various subpopulations of the study population, may be generated from the statistic variable records without requiring re-processing of raw clinical data for the various subpopulations.

According to further aspects, integrated clinical study analysis database 130 comprises data and derivative data from study subjects, structured such that a statistic and/or a table value specified in documentation for the clinical study can be computed using published equations applied directly to existing values of variables in the database. The database 130 comprises at least two of: a dataset structured one record per subject; a dataset structure one record per visit per subject; a data structured one record per measurement occasion per visit per subject; and a dataset structured one record per event per subject.

The system 100 is one example of how an integrated clinical study analysis database and access mechanism therefor may be implemented, and it will be appreciated that the present invention may be embodied in a number of ways other than that illustrated in FIG. 1. For example, the present invention may be implemented in a non-Web-based manner, e.g., an integrated clinical study analysis database could be resident at a “private” computer, such as a mainframe, desktop PC or other computer, and accessed directly on the computer or by using a terminal coupled directly to that computer or via, for example, a local area network (LAN). An integrated clinical study analysis database could also be implemented in a distributed manner, e.g., portions could be resident at a central computer, while other portions could be resident at client computers configured to access the database at the server computer using, for example, client software designed for use with the database. An apparatus for accessing an integrated clinical study analysis database may also take a number of forms other than a computer running a web browser that accesses an integrated clinical study analysis database server. For example, an apparatus for accessing an integrated clinical study analysis database could include a computer running specialized application software that could access and use clinical data and metadata in the integrated clinical study analysis database using a dial-up connection, LAN or wide area network (WAN).

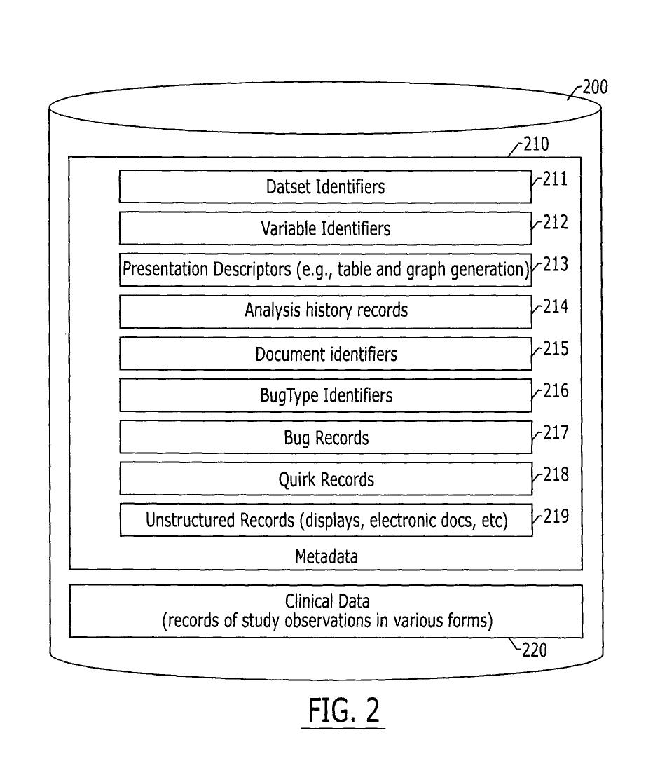

FIG. 2 illustrates an exemplary integrated clinical study analysis database 200 according to further embodiments of the present invention. The database 200 includes clinical data 220, e.g., records of study observations. Metadata 210 in the database 200 includes dataset identifiers 211 for the clinical data 220, variable identifiers 212 associated with an analytical interpretation of the clinical data 220, presentation descriptors (e.g., table and/or graph generation information), analysis history records 214 (e.g., records of various analyses performed on the clinical data 220), document identifiers 215 (e.g., forms, study definitions, and the like), “BugType” identifiers 216 (e.g., descriptions of types of errors that may be found in clinical data 220), “Bug” records 217 (specific instances of the types of bugs in the data 220), “Quirk” records 218 (e.g., descriptions of anomalies in analyses performed on the clinical data 220), and unstructured records 219 (e.g., displays associated with the data interpretation, electronic documents, and the like).

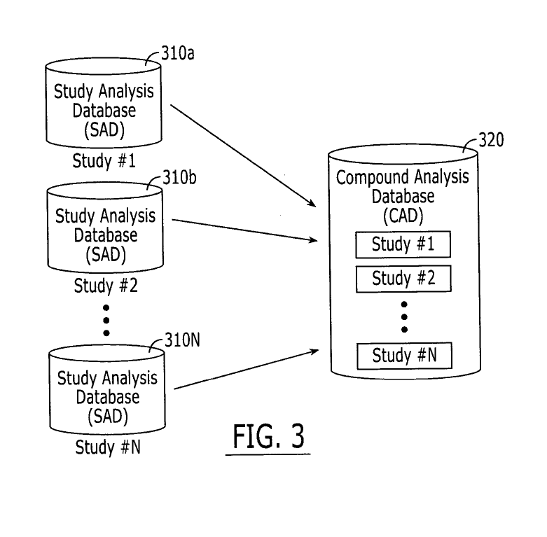

FIG. 3 illustrates an exemplary process, according to some embodiments of the present invention, by which such integrated clinical analyses databases may be created for clinical studies relating to a compound (e.g., a drug). Studies 1-N, which may, for example, study particular aspects related to effects of the compound for particular study populations and/or conditions, yield respective study analysis databases 310a, 310b, . . . , 310N, each of which may include integrated clinical data and metadata as described above. The individual study databases 310a, 310b, . . . , 310N are incorporated into a compound analysis database 320 including clinical data from the 1-N studies, along with metadata relating to the studies as described above. It will be appreciated that incorporation of the study analysis databases 310a, 310b, . . . , 310N into the compound analysis database 320 may occur in a serial fashion, a batch fashion, or a combination of serial and batch incorporation processes.

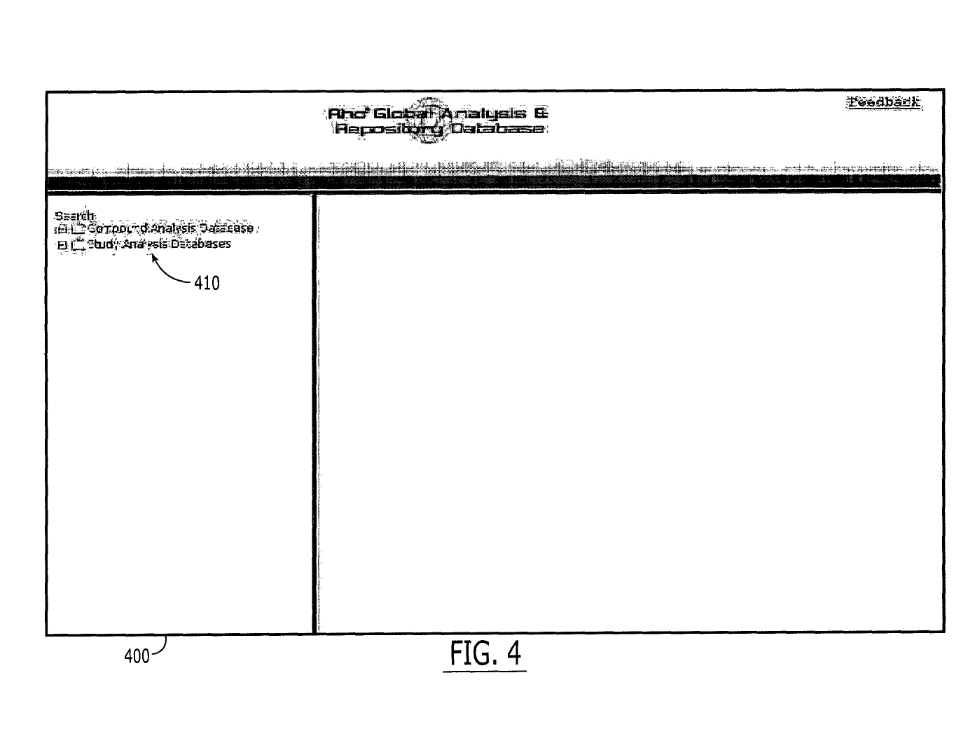

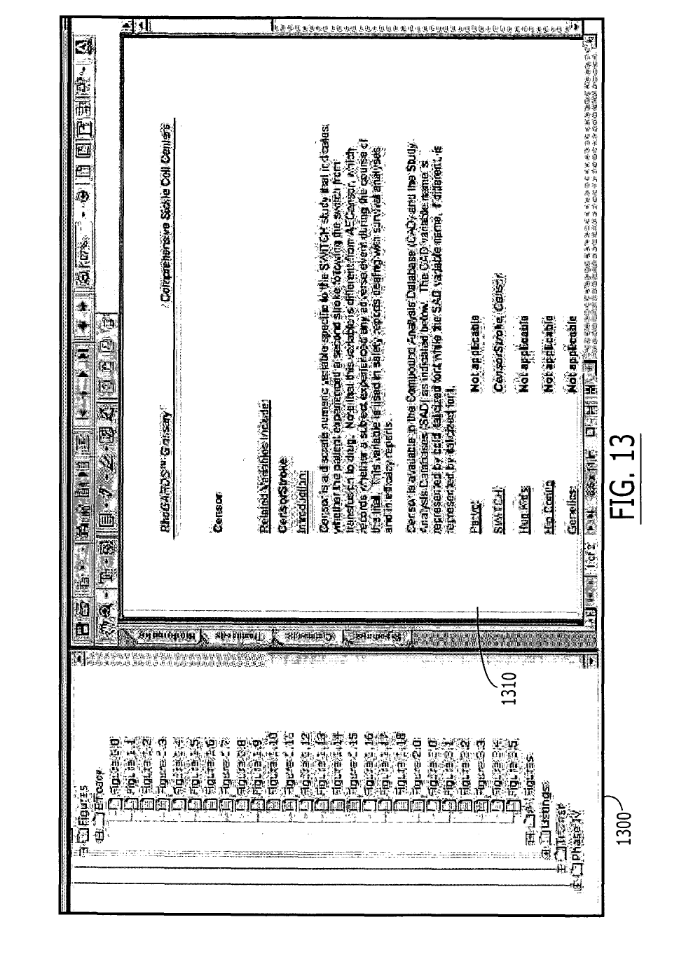

Additional embodiments of the present invention will now be described with reference to FIGS. 4-25, which are screen shots illustrating an exemplary web-based interface to an integrated clinical study analysis database, such as those described above with reference to FIGS. 1-3. In particular, FIGS. 4-25 illustrate a web browser interface to a web server, such as the web server 120 of FIG. 1, that provides access to and supports presentation of information in an integrated clinical study analysis database, such as the databases 130, 200, 310a, 310b, . . . , 310N, and 320 of FIG. 13. It will be understood that that screen shot illustrations of FIGS. 4-25 support apparatus for accessing and presenting clinical study analyses and associated information, such as client computers that receive user input and that, in cooperation with database server computers or other data processors, provide the database access and/or visual information presentation operations described with reference to FIGS. 4-25. It will be further understood that FIGS. 4-25 also support methods including the database access and/or visual information presentation operations described with reference to FIGS. 4-25, and software products that are configured to provide the data structures (databases) and/or database access and/or visual information presentation operations described with reference to FIGS. 4-25.

In particular, FIG. 4 illustrates a screen 400 that includes a tree menu display 410 that lists a plurality of integrated clinical study analysis databases (here including study and compound databases) that are accessible via a user interface that includes the screen 400. It will be appreciated that the user interface represented by the screen 400 (and succeeding screens) may include other components that are not shown for purposes of clarity of illustration, including, but not limited to, user input devices, such as a keyboard or mouse, and other user interface features, such as auditory outputs. Further discussion of FIGS. 4-25 assumes the use of such devices, for example, use of an user input device to select links in displayed screens, and it will be appreciate that additional discussion of such devices is unnecessary to the understanding of the embodiments illustrated in FIGS. 4-25.

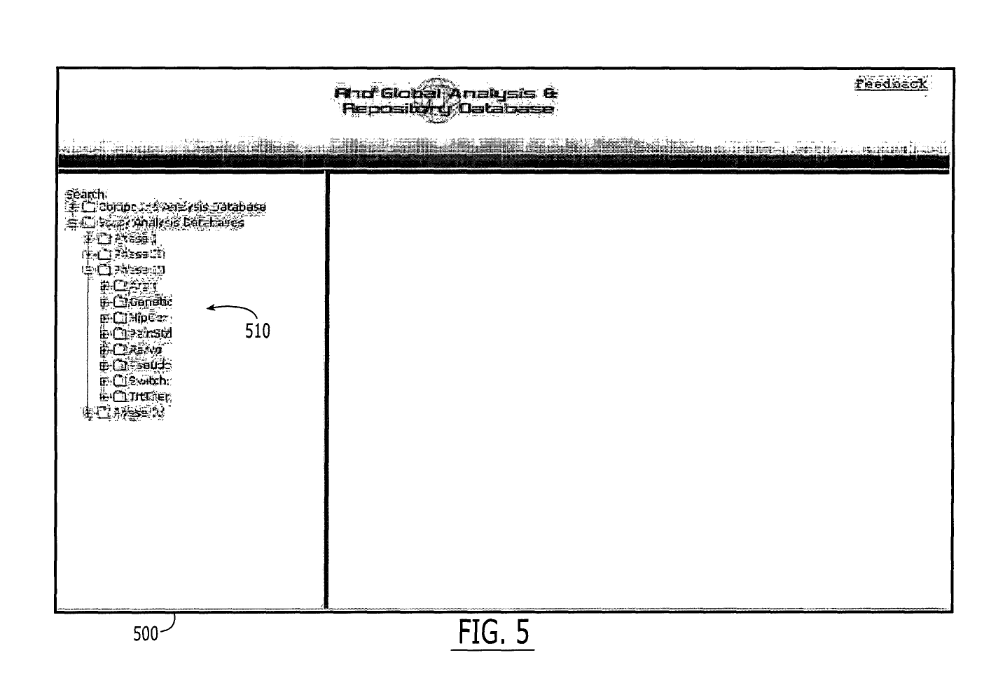

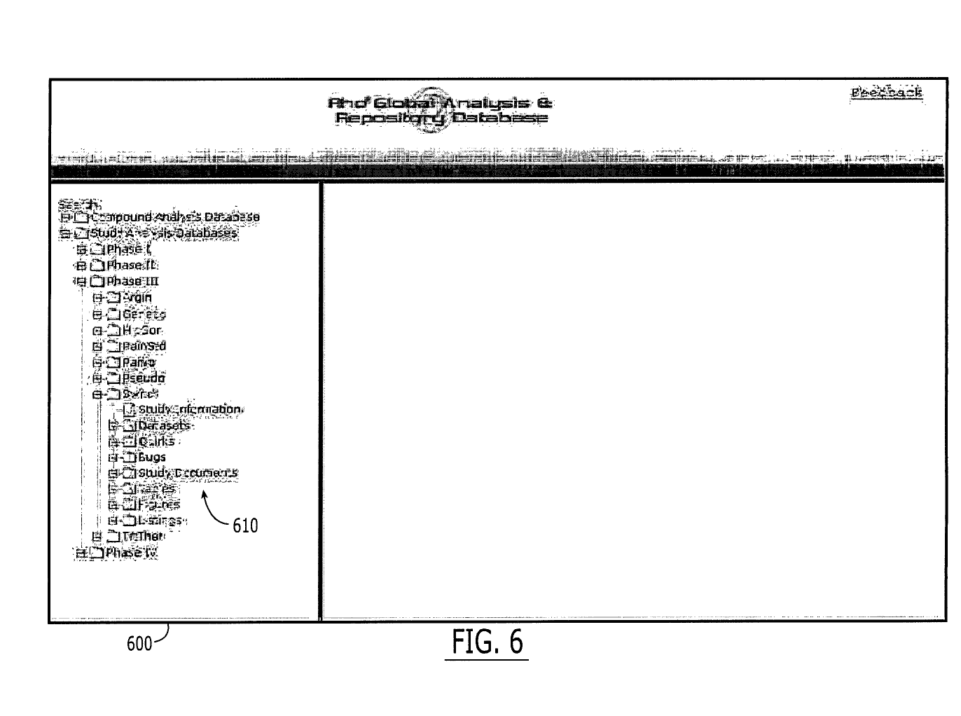

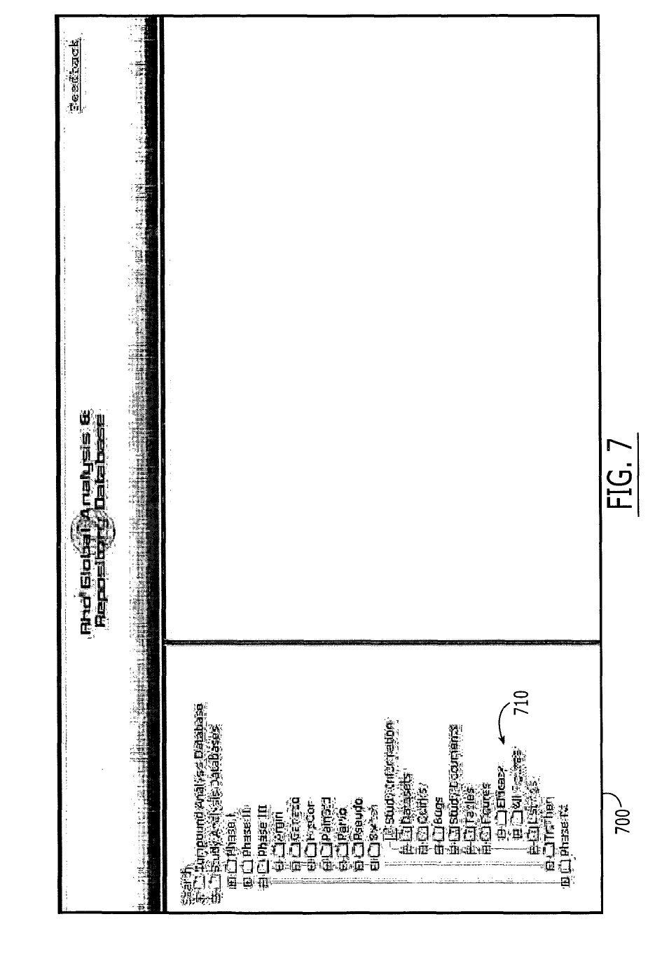

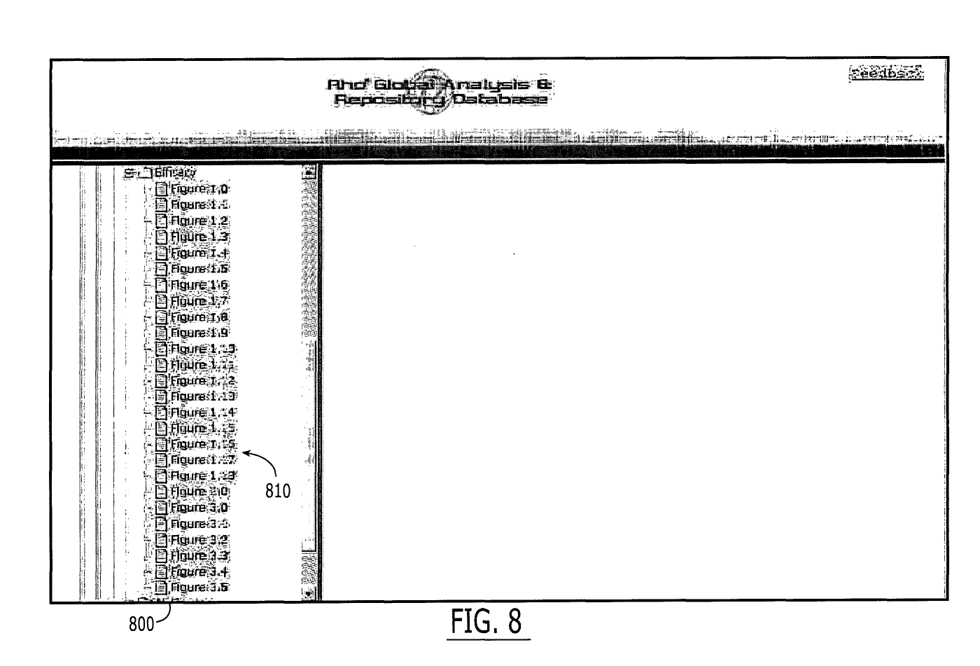

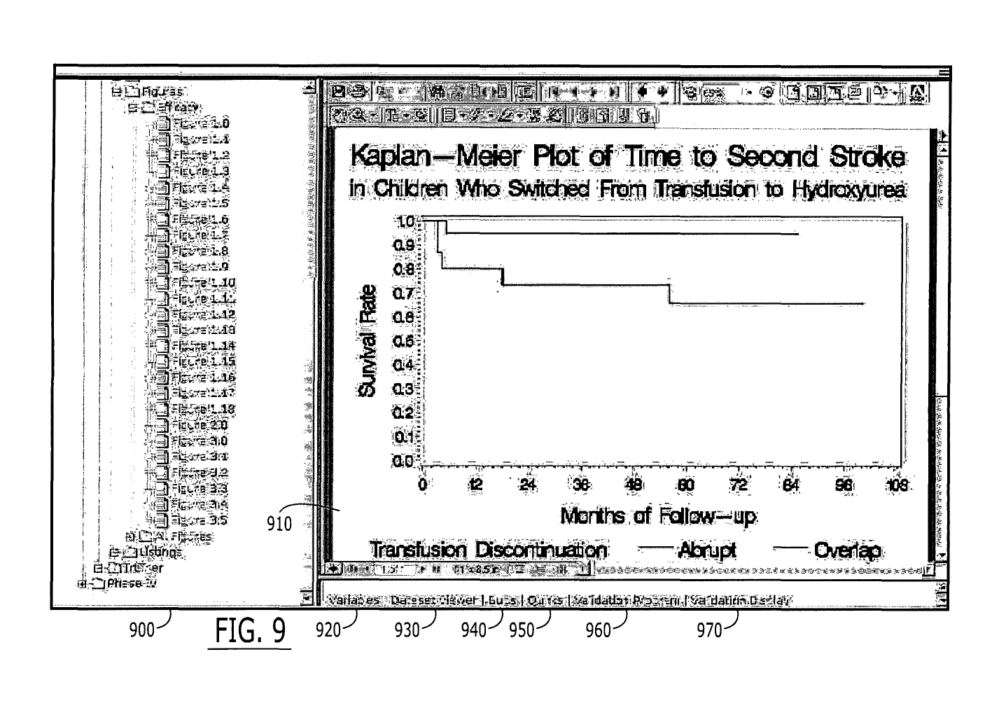

Turning to FIG. 5, which shows a second window 500, a user may drill down into the tree menu to access particular study analysis databases 510 falling under particular clinical trial phases. Referring to the window 600 shown in FIG. 6, within a study, a user can then drill down to access particular metadata 610, such as datasets, quirks, bugs, documents, etc., within a particular study analysis database. Referring to the screens 700 and 800 in FIGS. 7 and 8, the user can drill still further down to access particular presentations 710, 810 of analyses of clinical data which, for the example shown in FIG. 9, causes presentation of a display 910 associated with a particular statistical analysis of clinical data in a screen 900.

As shown, the screen 900 further includes links 920, 930, 940, 950, 96, 970 that can provide displays relating to data associated with generation of the analysis presented. The displays may be nested, i.e., links within the metadata display may be selected to display further underlying information that defines the analysis shown in FIG. 9, as described in further detail below.

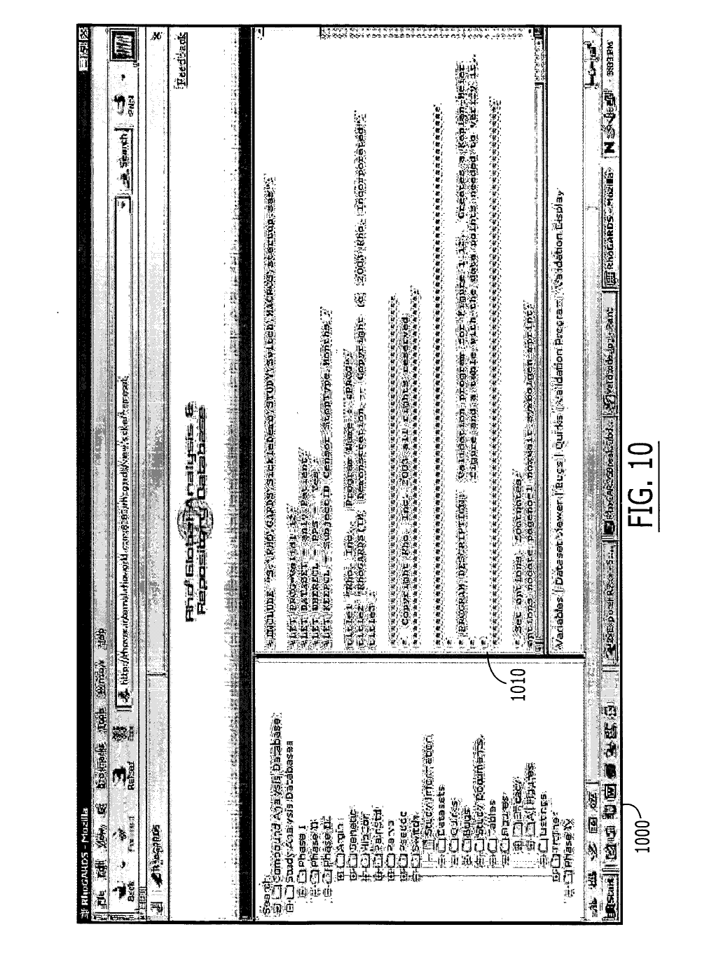

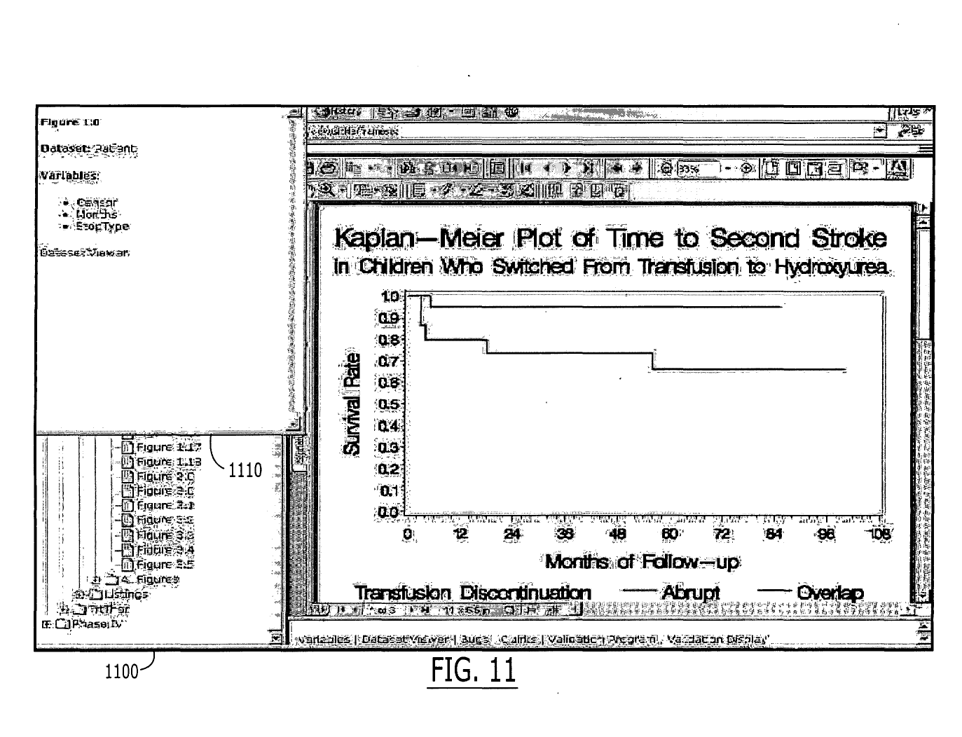

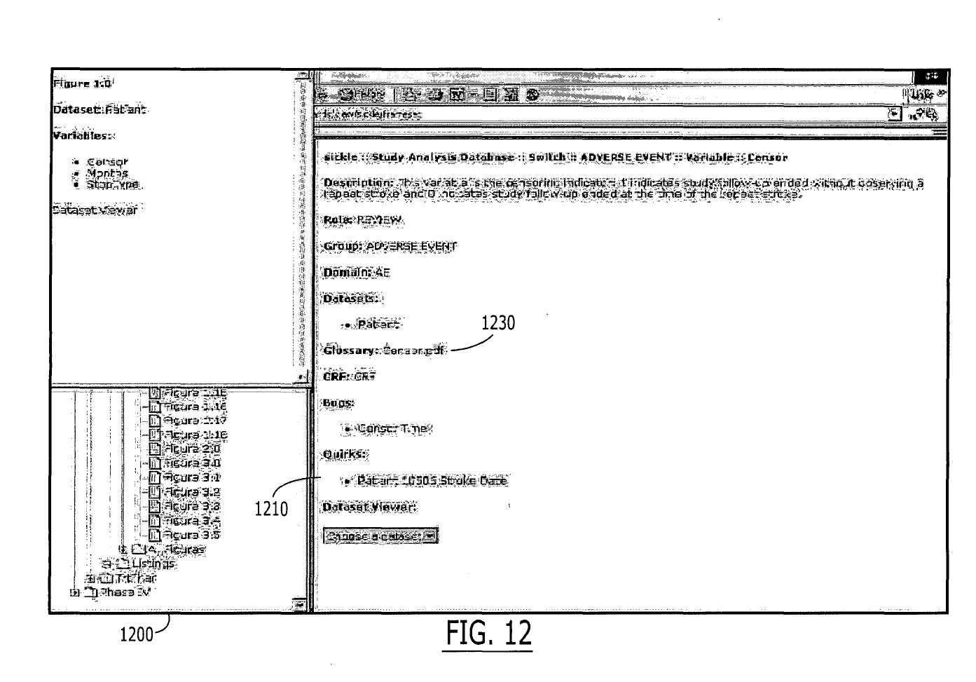

Still referring to FIG. 9, selection of the “validation program” link 960 results in the presentation of a screen 1000 including a display 1010 of statistical analysis program code used to generate the analysis, as shown in FIG. 10. It will be appreciated that such a display may be particularly useful to a reviewer seeking to determine the validity of the analysis. Referring to FIG. 11 in conjunction with FIG. 9, selection of a “variable” link 920 results in presentation of a screen 1100 including a display 1110 listing variables used in generating the analysis shown in FIG. 9. As shown in the screen 1200 of FIG. 12, selection of a link 1220 associated with one of the listed variables results in generation of a display 1210 giving a detailed description of the variable. Selection of a link 1230 within this display can lead to presentation of a display 1310 of a document providing a more detailed variable description in a screen 1300 shown in FIG. 13.

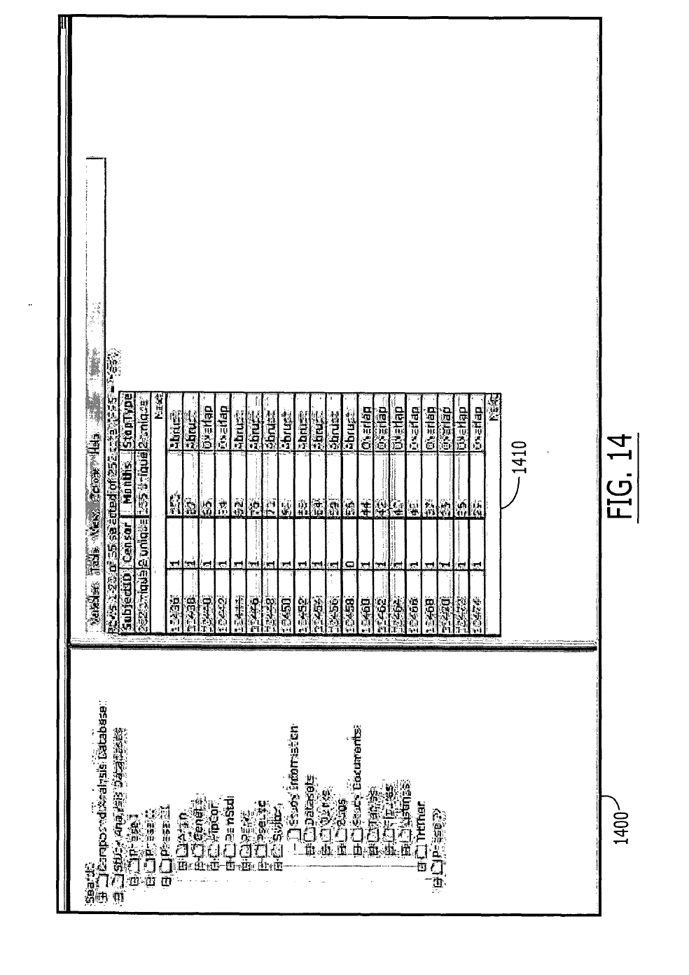

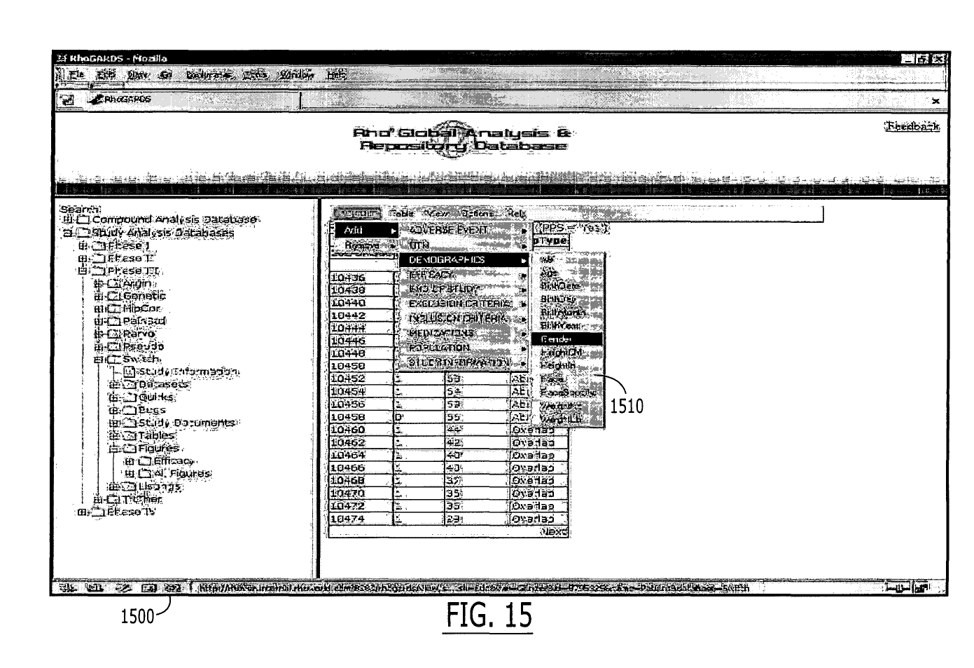

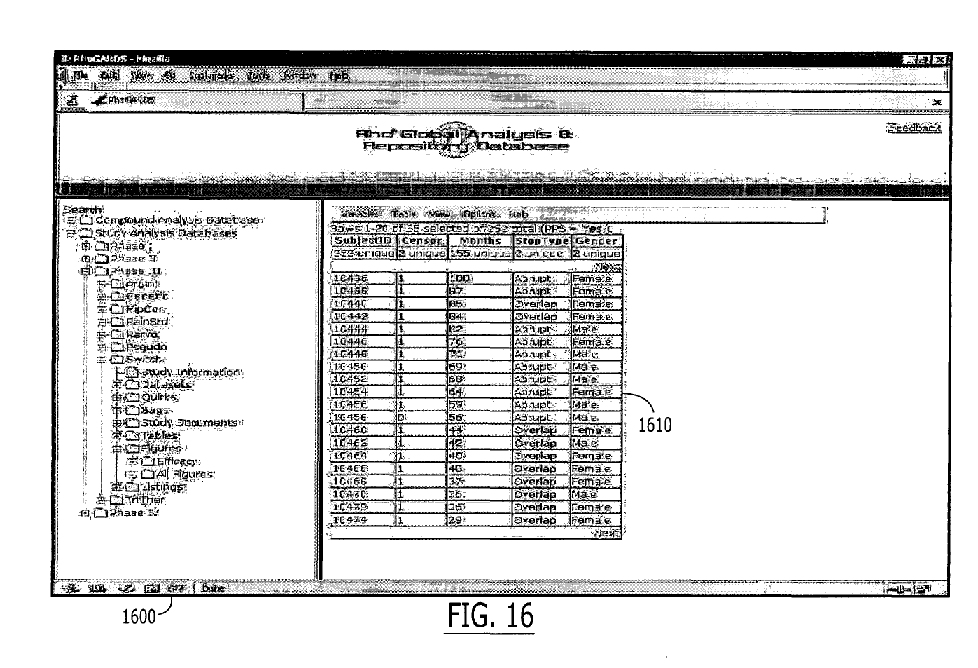

Referring now to FIG. 14 in conjunction with FIG. 9, selection of a “dataset viewer” link 930 results in presentation of a screen 1400 including a display 1410 of a dataset used to generate the analysis shown in FIG. 9. As shown in the screen 1500 of FIG. 15, within the dataset display, various menus 1510 can be selected to perform operations on the displayed dataset. For example, as shown in FIGS. 15 and 16, selection of a “Add/Demographics/Gender” menu option results in a new dataset display 1610 that includes gender data, as shown in the screen 1600 of FIG. 16.

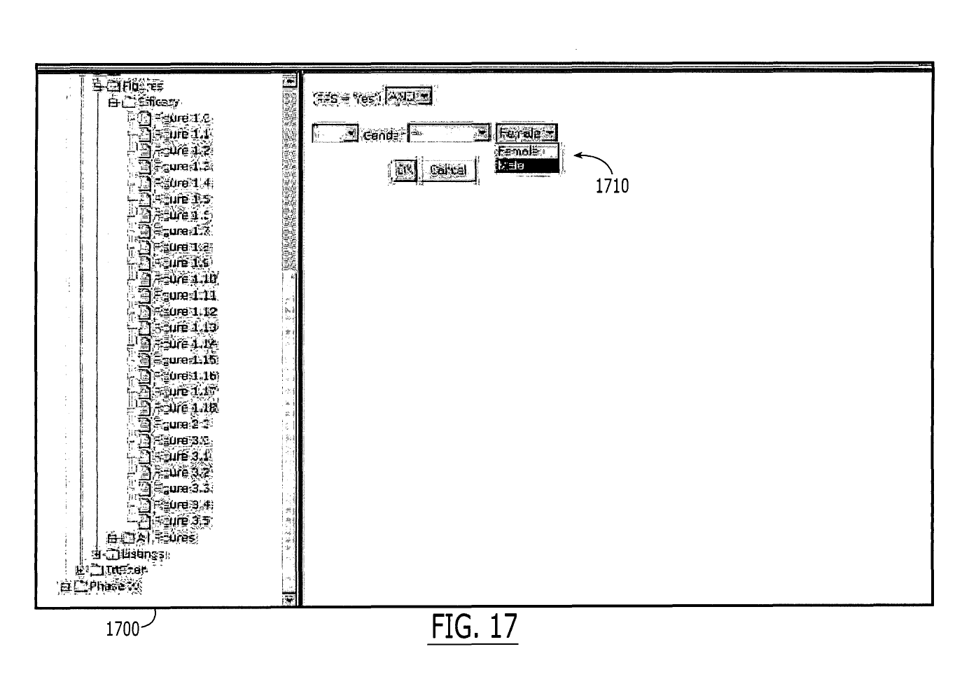

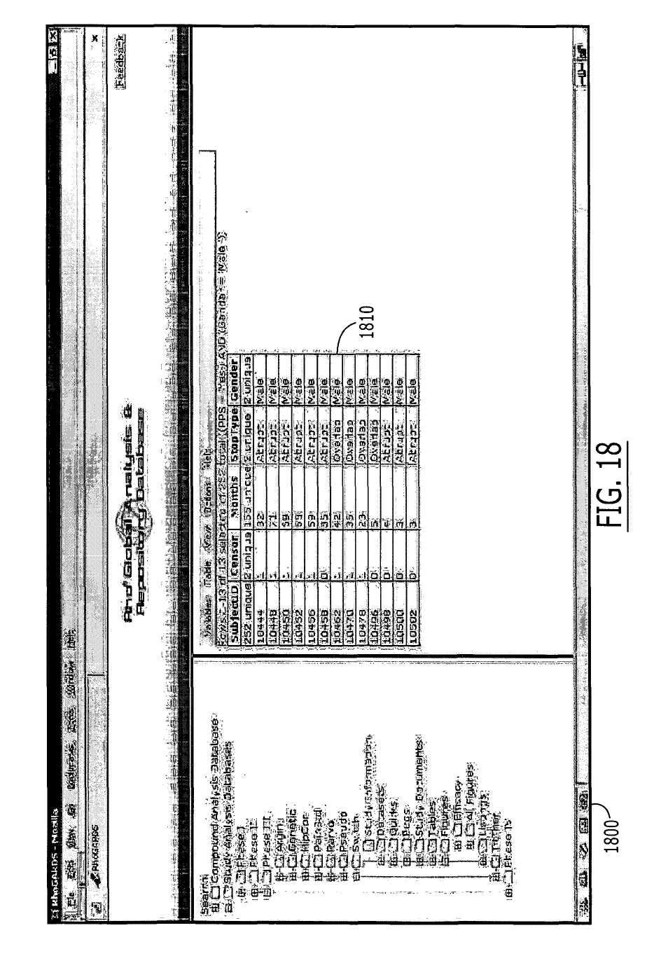

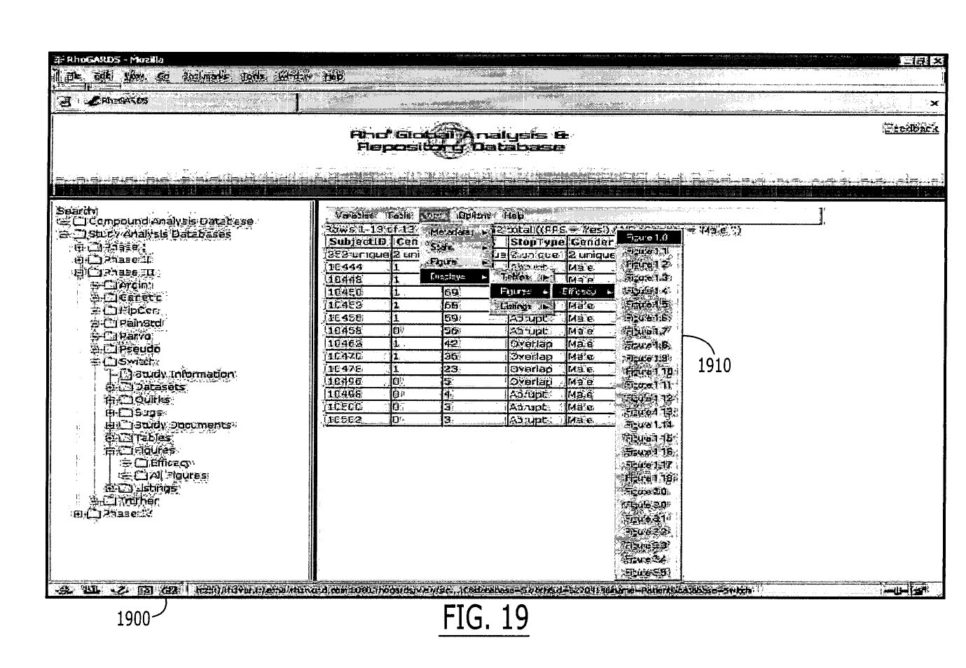

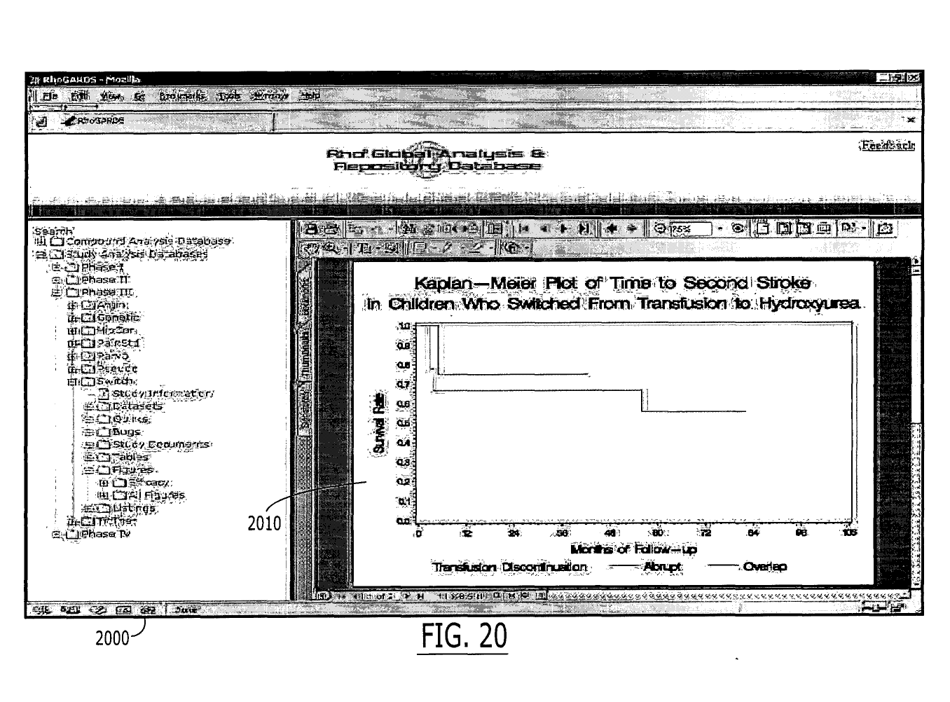

Links may be also provided to perform modifications of data used to generate prior analyses, such that refined analyses may be generated and displayed. For example, as shown in the screen 1700 of FIG. 17, other menu options can be used to filter data in the displayed data, e.g., by selecting a filter parameter 1710. As a result, a filtered dataset display 1810 may be generated, as shown in the screen 1800 of FIG. 18. As shown in the screen 1900 of FIG. 19, additional menu options 1910 may be provided to generate a new analysis display 2010, as shown in the screen 2000 of FIG. 20.

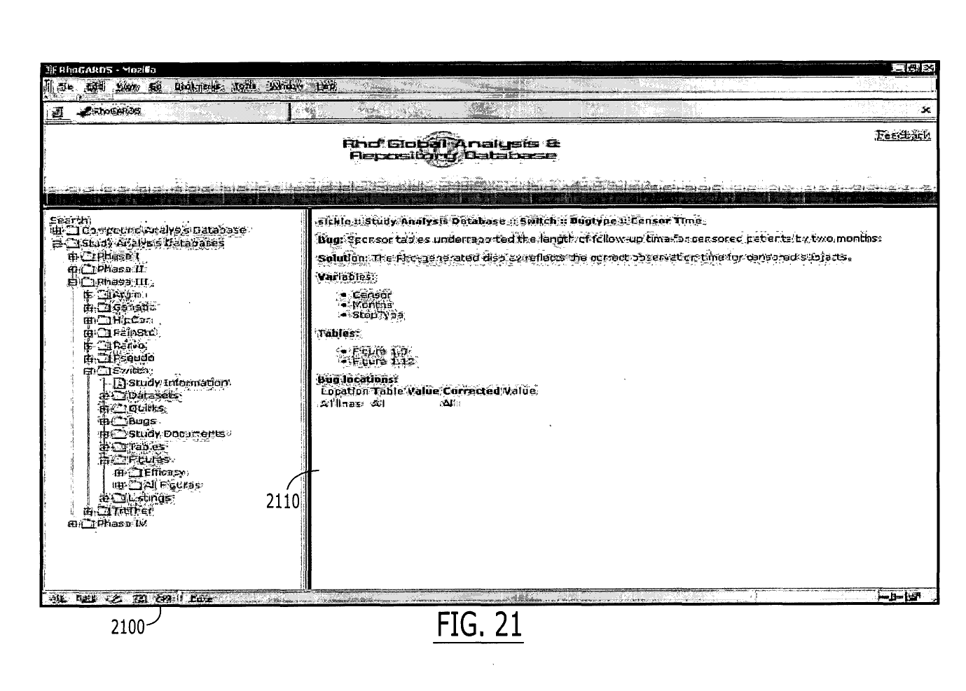

Referring now to FIG. 21 in conjunction with FIG. 9, selection of a “Bugs” link 940 yields a display 2110 in a screen 2100 that provides a description of an error associated with clinical data used to generate the analysis shown by the display 910 of FIG. 9. In the particular example shown, the display 2110 includes a description of the error and an identification of variables and presentations (e.g., tables and/or graphs) that were affected by the bug, along with a description of a correction made for the error.

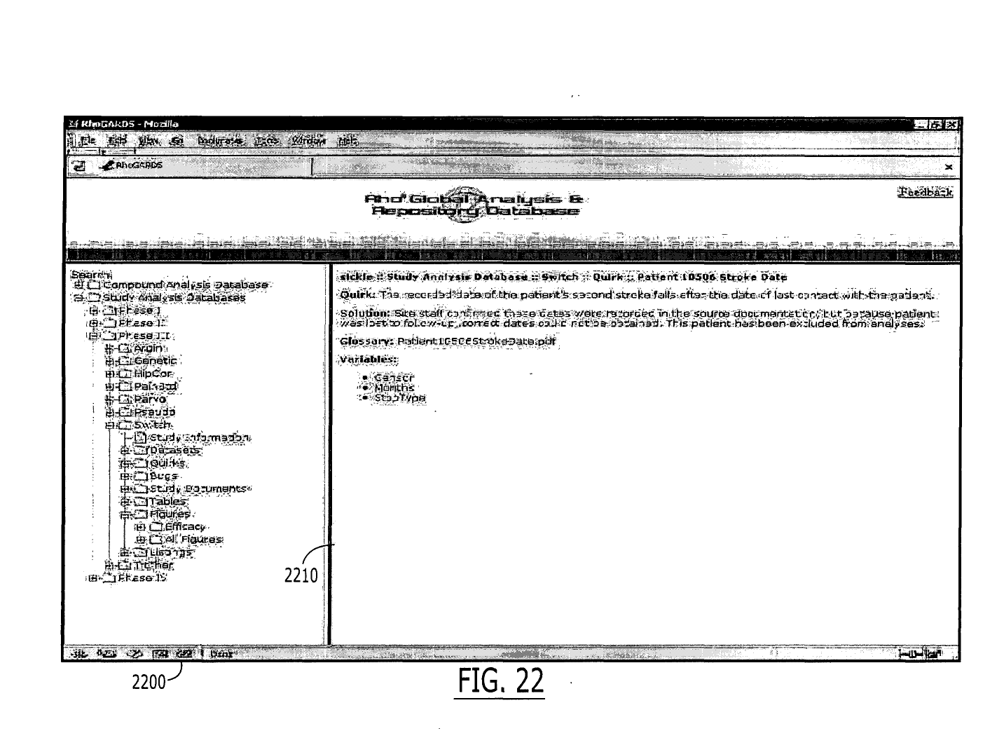

Analytical errors may be similarly accessed and presented. Referring now to FIG. 22 in conjunction with FIG. 9, selection of a “Quirks” link in the screen 900 may yield a screen 2200 including a display 2210 identifying an error in a prior analysis, and steps taken to rectify the error in generating the display 910 of FIG. 9.

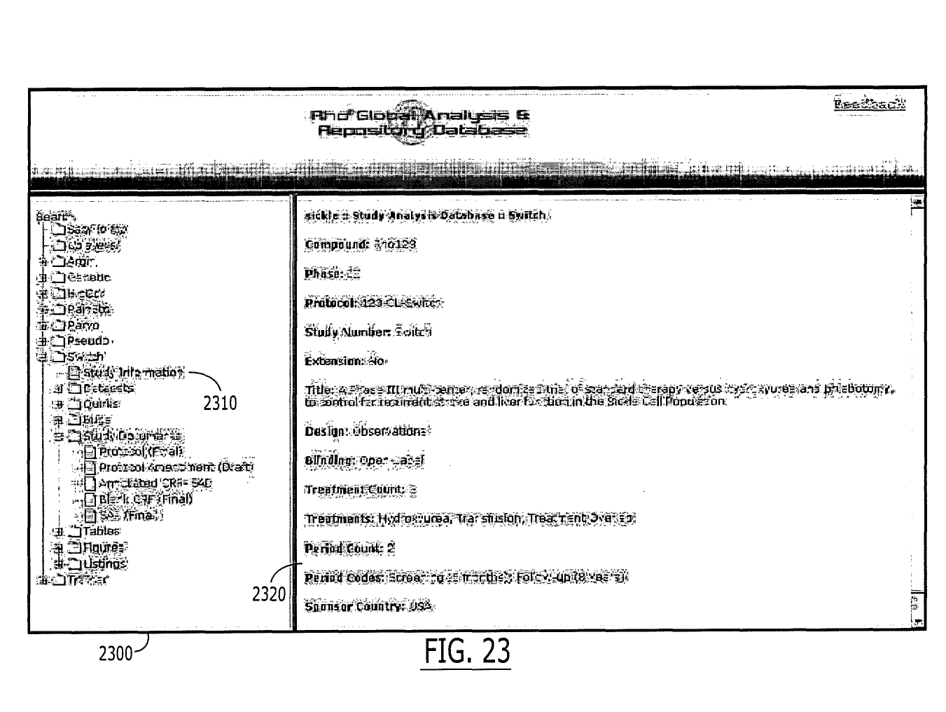

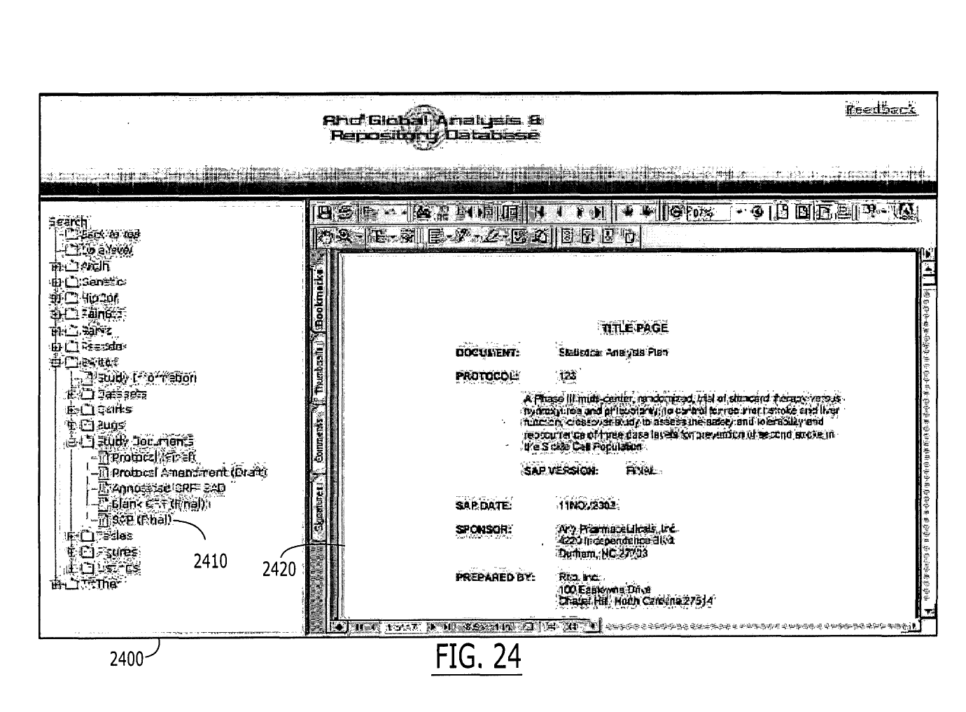

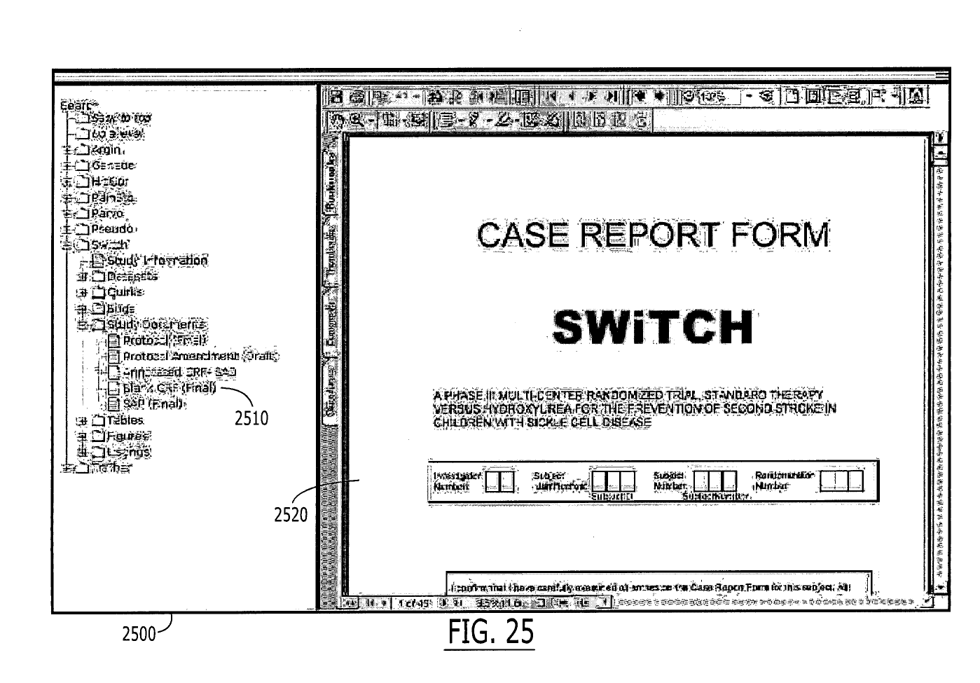

FIGS. 23-25 provide examples of how additional information related to clinical studies may be accessed via the tree menu described above. In particular, FIG. 23 illustrates a screen 2300 generated responsive to selection of a “Study Information” icon 2310. The screen 2300 includes a display 2320 of a description of a study, including, for the illustrated example, the compound involved in the study, the phase of the trial under which the study was conducted, and other characteristics of the study. FIG. 24 shows a screen 2400 generated responsive to selection of a “Statistical Analysis Plan” icon 2410. The screen 2400 includes a display of an Adobe “.pdf” file of a document describing a statistical analysis plan for the study. FIG. 25 illustrates a screen 2500 generated in response to selection of a “Case Report Form” icon 2510, including a display 2520 of a blank form used to collect clinical data for the study.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A software product comprising computer code embodied in a computer-accessible medium, the computer code comprising:
an integrated clinical study analysis database comprising clinical data from observations of study subjects of a population of study subjects of a clinical study and metadata that defines a structuring of the clinical data that supports generation of a statistical analysis of the population of study subjects specified by documentation of the clinical study, wherein the metadata provides statistical variable definitions for the statistical analysis such that plural instances of the statistical analysis can be generated without determining new values for the statistical variables.

2. A software product according to claim 1, further comprising computer code that is configured to accept respective statistical analysis instructions and to responsively access the clinical study analysis database and perform respective statistical computations using the statistical variables to generate respective instances of the statistical analysis.

3. A software product according to claim 1, wherein the integrated clinical study analysis database is configured to support a plurality of statistical analyses specified by the study documentation.

4. A software product according to claim 1, wherein the clinical data is arranged into a least one dataset including a dataset comprising respective records identifying respective ones of the study subjects and a dataset comprising respective records of respective clinical measurement occasions.

5. A software product according to claim 4, wherein the clinical data is arranged in a plurality of datasets including at least two of the following datasets:
a one-record-per-subject dataset;
a one-record-per-visit-per-subject dataset;
a one-record-per-measurement occasion-per-visit-per-subject dataset; and
a one-record-per-event-per-subject dataset.

6. A software product according to claim 5, wherein the one-record-per-event-per-subject dataset records at least one of adverse events, concomitant medication events, and unscheduled events.

7. A software product according to claim 1, wherein the metadata comprises a dataset comprising respective records that identify respective datasets in the clinical study analysis database and a dataset comprising respective records that identify respective statistical variables.

8. A software product according to claim 7, wherein the metadata comprises a one-record-per-dataset dataset and a one-record-per-variable dataset.

9. A software product according to claim 1, wherein the metadata comprises at least one of the following datasets:
a dataset comprising respective records specifying respective summary descriptions of respective studies;
a dataset comprising respective records specifying respective study documents;
a dataset comprising respective records specifying datasets complying with respective regulatory submission dataset requirements.

10. A software product according to claim 1, wherein the metadata comprises scientific metadata that comprises scientific information about the study, the clinical data, and/or the statistical analysis.

11. A software product according to claim 10, wherein the scientific metadata data comprises at least one of the following datasets:
a dataset comprising respective records including descriptions of respective statistical variables;
a dataset comprising respective records including descriptions of respective anomalies associated with the statistical analysis;
a dataset comprising respective records including descriptions of respective types of data errors that may be present in the clinical data;
a dataset comprising respective records including descriptions of respective data errors present in the clinical data;
a dataset comprising respective records of respective decisions made in structuring the clinical data.

12. A software product according to claim 10, wherein the scientific metadata data comprises computer files comprising study documents.

13. A software product according to claim 1, further comprising computer code that is executable to provide a user interface for presentation of the statistical analysis.

14. A software product according to claim 13, wherein the computer code that is executable to provide a user interface comprises server program code executable to provide a web server for access to the integrated clinical study analysis database.

15. A software product according to claim 14, wherein the metadata includes data configured to define a presentation of the statistical analysis, and wherein the server program code is executable to support display of the statistical analysis in a web browser window according to the metadata.

16. A software product comprising computer code embodied in a computer-accessible medium, the computer code comprising:
an integrated clinical study analysis database comprising data and derivative data from study subjects, structured such that a statistic and/or a table value specified in documentation for the clinical study can be computed using published equations applied directly to existing values of variables in the database, and which comprises at least two of:
a dataset structured one record per subject;
a dataset structure one record per visit per subject;
a data structured one record per measurement occasion per visit per subject; and
a dataset structured one record per event per subject.

17. A software product according to claim 16, further comprising computer code that is configured to accept respective statistical analysis instructions and to responsively access the clinical study analysis database and perform respective statistical computations using the variables to generate respective instances of a statistical analysis without generating new values for the variables.

18. A software product according to claim 16, wherein the integrated clinical study analysis database is configured to support a plurality of statistical analyses specified by study documentation.

19. A software product according to claim 16, wherein the integrated clinical study database comprises a dataset comprising respective records that identify respective datasets in the clinical study analysis database and a dataset comprising respective records that identify respective statistical variables.

20. A software product according to claim 19, wherein the integrated clinical study database comprises a one-record-per-dataset dataset and a one-record-per-variable dataset.

21. A software product according to claim 16, wherein the integrated clinical study database comprises at least one of the following datasets:
a dataset comprising respective records specifying respective summary descriptions of respective studies;
a dataset comprising respective records specifying respective study documents;
a dataset comprising respective records specifying datasets complying with respective regulatory submission dataset requirements.

22. A software product according to claim 16, wherein the integrated clinical study database comprises scientific metadata that describes a scientific basis for the statistical analysis.

23. A software product according to claim 22, wherein the scientific metadata data comprises at least one of the following datasets:
a dataset comprising respective records including descriptions of respective statistical variables;
a dataset comprising respective records including descriptions of respective anomalies associated with the statistical analysis;
a dataset comprising respective records including descriptions of respective types of data errors that may be present in the clinical data;
a dataset comprising respective records including descriptions of respective data errors present in the clinical data;
a dataset comprising respective records of respective decisions made in structuring the clinical data.

24. A software product according to claim 16, further comprising computer code that is executable to provide a user interface for presentation of the statistic and/or the table value.

25. A software product according to claim 24, wherein the computer code that is executable to provide a user interface comprises server program code executable to provide a web server for access to the integrated clinical study analysis database.

26. A software product according to claim 25, wherein the clinical study analysis database includes data configured to define a presentation of the statistic and/or the table value, and wherein the server program code is executable to support display of the statistic and/or the table value in a web browser window according to the metadata.

27. A software product comprising computer code embodied in a computer-accessible medium, the computer code comprising:
computer code configured to access an integrated clinical study analysis database comprising clinical data from observations of study subjects of a population of study subjects of a clinical study and metadata that defines a structuring of the clinical data that supports generation of a statistical analysis of the population of study subjects specified by documentation of the clinical study, wherein the metadata provides statistical variable definitions for the statistical analysis such that plural instances of the statistical analysis can be generated without determining new values for the statistical variables.

28. A software product according to claim 27, wherein the computer code configured to access an integrated clinical study analysis database comprises computer code that is executable to provide a user interface for presentation of the statistical analysis.

29. A software product according to claim 28, wherein the computer code that is executable to provide a user interface comprises server program code executable to provide a web server for access to the integrated clinical study analysis database.

30. A software product according to claim 29, wherein the server program code is executable to support display of the statistical analysis in a web browser window.

31. A software product comprising computer code embodied in a computer-accessible medium, the computer code comprising:
computer code configured to access an integrated clinical study analysis database comprising data and derivative data from study subjects, structured such that a statistic and/or a table value specified in documentation for the clinical study can be computed using published equations applied directly to existing values of variables in the database, and which comprises at least two of:
a dataset structured one record per subject;
a dataset structure one record per visit per subject;
a data structured one record per measurement occasion per visit per subject; and
a dataset structured one record per event per subject.

32. A software product according to claim 31, wherein the computer code configured to access an integrated clinical study analysis database comprises computer code that is executable to provide a user interface for presentation of the statistic and/or the table value.

33. A software product according to claim 32, wherein the computer code that is executable to provide a user interface comprises server program code executable to provide a web server for access to the integrated clinical study analysis database.

34. A software product according to claim 33, wherein the server program code is executable to support display of the statistic and/or the table value in a web browser window.

35. A software product comprising computer code embodied in a computer-accessible medium, the computer code comprising:
code configured to access and navigate a clinical study analysis database and to support display of information therein.

36. A software product according to claim 35, further comprising code configured to provide a user interface for presentation of information in the clinical study analysis database.

37. A software product according to claim 35, further comprising code configured to access and cause display of a pre-generated analysis of data in the clinical study analysis database.

38. A software product according to claim 37, further comprising code configured to access and cause display of a variable used to generate the pregenerated analysis.

39. A software product according claim 37, further comprising code configured to access and cause display of a least one of:
a description of a statistical variable used in the pregenerated analysis;
a description of an anomaly associated with the pregenerated analysis;
a description of a type of data error that may be present in data used to generate the pregenerated analysis;
a description of a data error present in data used to generate the pregenerated analysis;
a description of a decision made in structuring data for the pregenerated analysis; and
a document associated with the pregenerated analysis.

40. A software product according to claim 37, further comprising code configured to access and cause display of a computer program used to generate the pre-generated analysis.

41. A software product according to claim 37, further comprising code configured to access and cause display of a validation of the pregenerated analysis.

42. A software product according to claim 37, further comprising code configured to sort and/or graph and/or calculate statistics of data used to generate the pregenerated analysis.

43. A system for managing clinical study data, the system comprising:
a computer configured to maintain an integrated clinical study analysis database comprising clinical data from observations of study subjects of a population of study subjects of a clinical study and metadata that defines a structuring of the clinical data that supports generation of a statistical analysis of the population of study subjects specified by documentation of the clinical study, wherein the metadata provides statistical variable definitions for the statistical analysis such that plural instances of the statistical analysis can be generated without determining new values for the statistical variables.

44. A system according to claim 43, wherein the computer is further configured to accept respective statistical analysis instructions and to responsively access the clinical study analysis database and perform respective statistical computations using the statistical variables to generate respective instances of the statistical analysis.

45. A system according to claim 43, wherein the integrated clinical study analysis database is configured to support a plurality of statistical analyses specified by the study documentation.

46. A system according to claim 43, wherein the clinical data is arranged into a least one dataset including a dataset comprising respective records identifying respective ones of the study subjects and a dataset comprising respective records of respective clinical measurement occasions.

47. A system according to claim 46, wherein the clinical data is arranged into a plurality of datasets comprising at least two of the following datasets:
a one-record-per-subject dataset;
a one-record-per-visit-per-subject dataset;
a one-record-per-measurement occasion-per-visit-per-subject dataset; and
a one-record-per-event-per-subject dataset.

48. A system according to claim 43, wherein the metadata comprises scientific metadata that comprises scientific information about the study, the clinical data, and/or the statistical analysis.

49. A system according to claim 43, wherein the computer is further configured to provide a user interface for presentation of the statistical analysis.

50. A system according to claim 49, wherein the computer is further configured to provide a web server for access to the integrated clinical study analysis database.

51. A system according to claim 50, wherein the web server is configured to support display of the statistical analysis in a web browser window.

52. A system for managing clinical study data, the system comprising:
a computer configured to maintain an integrated clinical study analysis database comprising data and derivative data from study subjects, structured such that a statistic and/or a table value specified in documentation for the clinical study can be computed using published equations applied directly to existing values of variables in the database, and which comprises at least two of:
a dataset structured one record per subject;
a dataset structure one record per visit per subject;
a data structured one record per measurement occasion per visit per subject; and
a dataset structured one record per event per subject.

53. A system according to claim 52, wherein the computer is further configured to accept respective statistical analysis instructions and to responsively access the clinical study analysis database and perform respective statistical computations using the variables to generate respective instances of a statistical analysis without generating new values for the variables.

54. A system according to claim 52, wherein the integrated clinical study analysis database is configured to support a plurality of statistical analyses specified by study documentation.

55. A system according to claim 52, wherein the integrated clinical study database comprises a dataset comprising respective records that identify respective datasets in the clinical study analysis database and a dataset comprising respective records that identify respective statistical variables.

56. A system according to claim 52, wherein the integrated clinical study database comprises scientific metadata that describes a scientific basis for the statistical analysis.

57. A system according to claim 52, wherein the computer is further configured to provide a user interface for presentation of the statistic and/or the table value.

58. A system according to claim 57, wherein the computer is further configured to provide a web server for access to the integrated clinical study analysis database.

59. A system according to claim 58, wherein the computer is further configured to support display of the statistic and/or the table value in a web browser window.

60. A system for interacting with a clinical study analysis database, the system comprising:
a computer configured to access and navigate the clinical study analysis database and to support display of information therein.

61. A system according to claim 60, wherein the computer is further configured to provide a user interface for presentation of information in the clinical study analysis database.

62. A system according to claim 60, wherein the computer is further configured to access and cause display of a pre-generated analysis of data in the clinical study analysis database.

63. A system according to claim 62, wherein the computer is further configured to access and cause display of a variable used to generate the pregenerated analysis.

64. A system according claim 62, wherein the computer is further configured to access and cause display of a least one of:
a description of a statistical variable used in the pregenerated analysis;
a description of an anomaly associated with the pregenerated analysis;
a description of a type of data error that may be present in data used to generate the pregenerated analysis;
a description of a data error present in data used to generate the pregenerated analysis;
a description of a decision made in structuring data for the pregenerated analysis; and
a document associated with the pregenerated analysis.

65. A system according to claim 62, wherein the computer is further configured to access and cause display of a computer program used to generate the pre-generated analysis.

66. A system according to claim 62, wherein the computer is further configured to access and cause display of a validation of the pregenerated analysis.

67. A system according to claim 62, wherein the computer is further configured to sort and/or graph and/or calculate statistics of data used to generate the pregenerated analysis.

68. A method of managing clinical study data, the method comprising:
providing an integrated clinical study analysis database comprising clinical data from observations of study subjects of a population of study subjects of a clinical study and metadata that defines a structuring of the clinical data that supports generation of a statistical analysis of the population of study subjects specified by documentation of the clinical study, wherein the metadata provides statistical variable definitions for the statistical analysis such that plural instances of the statistical analysis can be generated without determining new values for the statistical variables.

69. A method according to claim 68, further comprising accepting respective statistical analysis instructions and responsively accessing the clinical study analysis database and performing respective statistical computations using the statistical variables to generate respective instances of the statistical analysis.

70. A method according to claim 68, wherein the clinical data is arranged into a least one dataset including a dataset comprising respective records identifying respective ones of the study subjects and a dataset comprising respective records of respective clinical measurement occasions.

71. A method according to claim 70, wherein clinical data is arranged into a plurality of datasets comprising at least two of the following datasets:
a one-record-per-subject dataset;
a one-record-per-visit-per-subject dataset;
a one-record-per-measurement occasion-per-visit-per-subject dataset; and
a one-record-per-event-per-subject dataset.

72. A method according to claim 71, wherein the one-record-per-event-per-subject dataset records at least one of adverse events, concomitant medication events, and unscheduled events.

73. A method according to claim 68, wherein the metadata comprises a dataset comprising respective records that identify respective datasets in the clinical study analysis database and a dataset comprising respective records that identify respective statistical variables.

74. A method according to claim 73, wherein the metadata comprises a one-record-per-dataset dataset and a one-record-per-variable dataset.

75. A method according to claim 68, wherein the metadata comprises at least one of the following datasets:
a dataset comprising respective records specifying respective summary descriptions of respective studies;
a dataset comprising respective records specifying respective study documents;
a dataset comprising respective records specifying datasets complying with respective regulatory submission dataset requirements.

76. A method according to claim 68, wherein the metadata comprises scientific metadata that comprises scientific information about the study, the clinical data, and/or the statistical analysis.

77. A method according to claim 76, wherein the scientific metadata data comprises at least one of the following datasets:
a dataset comprising respective records including descriptions of respective statistical variables;
a dataset comprising respective records including descriptions of respective anomalies associated with the statistical analysis;
a dataset comprising respective records including descriptions of respective types of data errors that may be present in the clinical data;
a dataset comprising respective records including descriptions of respective data errors present in the clinical data;
a dataset comprising respective records of respective decisions made in structuring the clinical data.

78. A method according to claim 68, further comprising providing a user interface for presentation of the statistical analysis.

79. A method according to claim 68, wherein providing a user interface comprises providing a web server for access to the integrated clinical study analysis database.

80. A method according to claim 79, wherein the web server supports display of the statistical analysis in a web browser window according to the metadata.

81. A method of managing clinical study data, the method comprising:
providing an integrated clinical study analysis database comprising data and derivative data from study subjects, structured such that a statistic and/or a table value specified in documentation for the clinical study can be computed using published equations applied directly to existing values of variables in the database, and which comprises at least two of:
a dataset structured one record per subject;
a dataset structure one record per visit per subject;
a dataset structured one record per measurement occasion per visit per subject; and
a dataset structured one record per event per subject.

82. A method according to claim 81, further comprising accepting respective statistical analysis instructions and responsively accessing the clinical study analysis database and performing respective statistical computations using the variables to generate respective instances of a statistical analysis without generating new values for the variables.

83. A method according to claim 81, wherein the integrated clinical study database comprises a dataset comprising respective records that identify respective datasets in the clinical study analysis database and a dataset comprising respective records that identify respective statistical variables.

84. A method according to claim 83, wherein the integrated clinical study database comprises a one-record-per-dataset dataset and a one-record-per-variable dataset.

85. A method according to claim 81, wherein the integrated clinical study database comprises at least one of the following datasets:
a dataset comprising respective records specifying respective summary descriptions of respective studies;
a dataset comprising respective records specifying respective study documents;
a dataset comprising respective records specifying datasets complying with respective regulatory submission dataset requirements.

86. A method according to claim 81, wherein the integrated clinical study database comprises scientific metadata that describes a scientific basis for the statistical analysis.

87. A method according to claim 86, wherein the scientific metadata data comprises at least one of the following datasets:
a dataset comprising respective records including descriptions of respective statistical variables;
a dataset comprising respective records including descriptions of respective anomalies associated with the statistical analysis;
a dataset comprising respective records including descriptions of respective types of data errors that may be present in the clinical data;
a dataset comprising respective records including descriptions of respective data errors present in the clinical data;
a dataset comprising respective records of respective decisions made in structuring the clinical data.

88. A method according to claim 81, further comprising providing a user interface for presentation of the statistic and/or the table value.

89. A method according to claim 88, wherein providing a user interface comprises providing a web server for access to the integrated clinical study analysis database.

90. A method according to claim 89, wherein the web server supports display of the statistic and/or the table value in a web browser window.
